(19) United States
(12) Patent Application Publication
(10) Pub. No.: US 2007/0049265 A1
(43) Pub. Date: Mar. 1, 2007

(54) Apparatus and method for local device management

(76) Inventors: Biju R. Kaimal, Emeryville, CA (US); Richard T. Chow, Santa Clara, CA (US); Vadim Draluk, Cupertino, CA (US); Guy W. Martin, Morgan Hill, CA (US)

Correspondence Address: MOTOROLA INC, 600 NORTH US HIGHWAY 45, ROOM AS437, LIBERTYVILLE, IL, 60048-5343, US

(21) Appl. No.: 11/215,262

(22) Filed: Aug. 30, 2005

(51) Int. Cl. H04Q 7/20

(52) U.S. Cl. 455/423

(57) ABSTRACT

A method and apparatus for local device management. A signing server can generate a local provisioning packet and send the local provisioning packet to a requesting device management server. The device management server can transfer the local provisioning packet to a wireless communication device. The wireless communication device can compare a device identifier to a unique identifier in the wireless communication device and install a bootstrap packet in the wireless communication device if the device identifier matches the unique identifier in the wireless communication device. The wireless communication device may also verify that the packet was signed by the signing server as a condition on installing the bootstrap packet.

### BACKGROUND

1. Field

The present disclosure is directed to a method and apparatus for local device management. More particularly, the present disclosure is directed securely providing for a local device management session between a device management server and a wireless communication device locally connected to the device management server.

2. Description of Related Art

Presently, the ability to change the device management tree in a wireless communication device is a powerful feature. For example, this ability is used over the air in a wireless wide area network to change the behavior of a cellular phone by enabling and/or disabling features or modifying existing features. These features can be enabled, disabled, or modified by changing configuration values that are stored in the device management tree. Modifying the features is powerful because these features are often used for generating revenue for wireless service providers. Unauthorized enablement of a feature may result in a user effectively stealing the feature from a wireless service provider. The act of modifying the features is also powerful and should be restricted because it may be used to violate Federal Communications Commission rules or to sabotage a wireless network. Thus, the ability to change the device management tree on the wireless communication device should be limited. Therefore, such production environments are usually limited to an operator who runs wireless device management servers.

However, in a development type scenario or carrier testing scenario, there can be need to change the device management tree to test out a particular scenario without relying on the ability to initiate a device management session over the air. For example, an over the air infrastructure may not be set up or it may be unavailable. Unfortunately, there is currently no means for secure local device management. Thus, there is a need for a method and apparatus for local device management.

### SUMMARY

A method and apparatus for local device management. A signing server can generate a local provisioning packet and send the local provisioning packet to a requesting device management server. The device management server can transfer the local provisioning packet to a wireless communication device. The wireless communication device can compare a device identifier to a unique identifier in the wireless communication device and verifies that the packet was signed by the signing server. It can install a bootstrap packet in the wireless communication device if the device identifier matches the unique identifier in the wireless communication device and if it could successfully verify that the local provisioning packet was signed by the signing server.

### BRIEF DESCRIPTION OF THE DRAWINGS

The embodiments of the present disclosure will be described with reference to the following figures, wherein like numerals designate like elements, and wherein:

FIG. 1 is an exemplary illustration of a system;

FIG. 2 is an exemplary illustration of a local provisioning packet;

FIG. 3 is an exemplary block diagram of a wireless communication device;

FIG. 4 is an exemplary block diagram of a remote signing server;

FIG. 5 is an exemplary block diagram of a local device management server;

FIG. 6 is an exemplary flowchart illustrating the operation of a wireless communication device;

FIG. 7 is an exemplary flowchart illustrating the operation of a local device management server; and

FIG. 8 is an exemplary flowchart illustrating the operation of a remote signing server.

### DETAILED DESCRIPTION

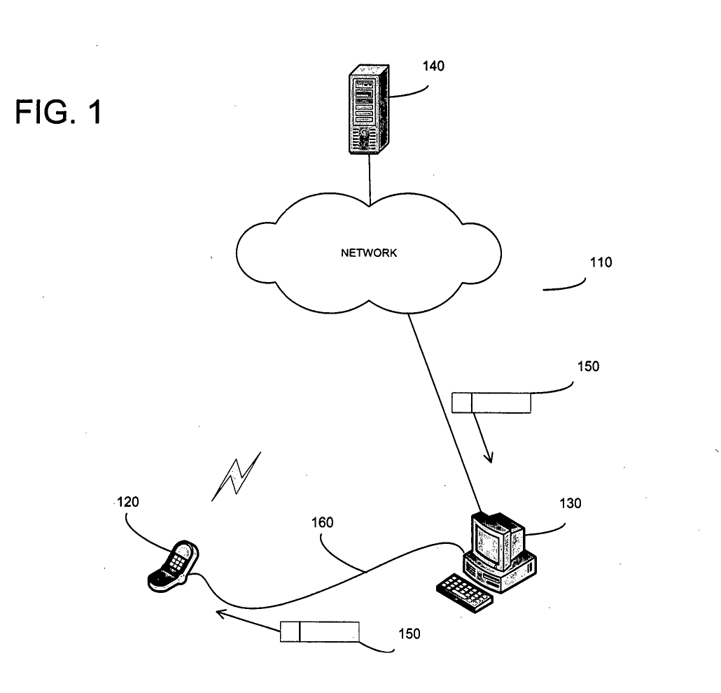

FIG. 1 is an exemplary block diagram of a system 100 according to one embodiment. The system 100 can include a signing server 140, a network 110, a device management server 130, a wireless communication device 120, a local interface 160 and a local provisioning packet 150. The wireless communication device 120 may be a wireless telephone, a cellular telephone, a personal digital assistant, a pager, a personal computer, a selective call receiver, or any other device that is capable of sending and receiving communication signals on a network including wireless network.

In an exemplary embodiment, the signing server 140 and the device management server 130 can be connected to the network 110. The wireless communication device 120 may also communicate with the network 110 using wired or wireless communication signals. The local interface 160 may be wireless, wired, infrared, or any other local interface. The network 110 may include any type of network that is capable of sending and receiving signals, such as wireless signals. For example, the network 110 may include a wireless telecommunications network, a cellular telephone network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals.

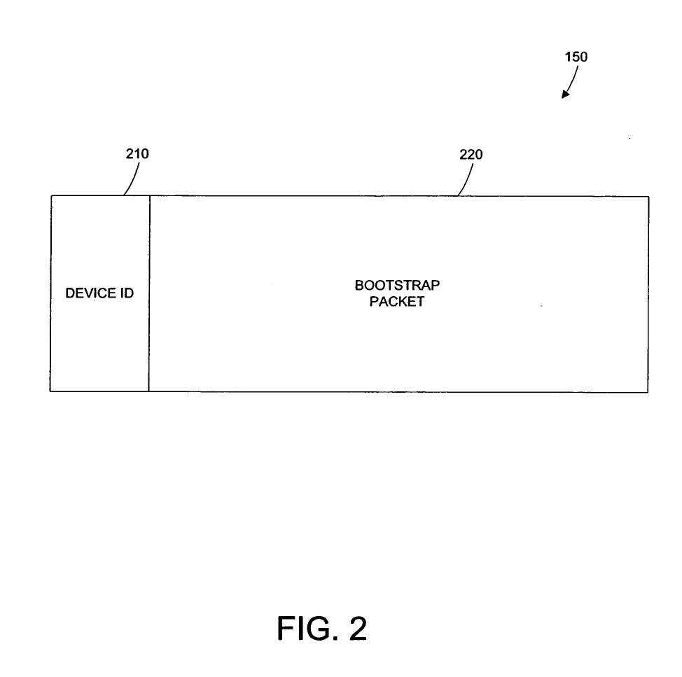

FIG. 2 is an exemplary illustration of a local provisioning packet 150. The local provisioning packet 150 can include a device identifier 210 and a bootstrap packet 220. The device identifier 210 can identify a specific wireless communication device 120 for a local device management session. The bootstrap packet 220 can include initial information sent to the specific wireless communication device 120 so the specific wireless communication device 120 can communicate with the device management server 130. For example, the bootstrap packet 220 can include a server address, port information, and other information useful for the wireless communication device 120 to contact the device management server 130.

In operation, the wireless communication device 120 can be locally connected to the device management server 130. The device management server 130 can send a registration to the signing server 140 for a local direct device management session with the wireless communication device 120. The signing server 140 can receive the registration, generate the local provisioning packet 150, and send the local provisioning packet to the requesting device management server 130. The device management server 130 can receive the local provisioning packet 150 and transfer the local provisioning packet 150 to the wireless communication device 120. The wireless communication device 120 can compare the device identifier 210 to a unique identifier in the wireless communication device 120 and install the bootstrap packet 220 in the wireless communication device 120 if the device identifier 210 matches the unique identifier in the wireless communication device 120. The wireless communication device 120 can also verify that the local provisioning packet 220 was signed by the signing server 140. The wireless communication device 120 can then open a local device management session with the device management server 130 when the bootstrap packet 220 is installed.

For example, a third-party software developer with a device management server 130 may need to change the device management tree on a wireless communication device 120. The third-party software developer can register as a developer for the specific wireless communication device 120 by registering with a developer program at the signing server 140. The signing server 140 can manage developer requests to give the registered developers the ability to perform local device management sessions. During registration, the signing server 140 can generate a local provisioning packet 150 that includes a device management bootstrap packet in a language for describing data synchronization protocol requests and response packets. The local provisioning packet 150 can include the device id of the wireless communication device 120 being registered as a development device. The signing server can then cryptographically sign the local provisioning packet 150 for security purposes. The local provisioning packet 150 can be sent to the developer at the device management server 130 as a file. The developer can then send the local provisioning packet file 150 to the phone via the local interface 160. When the code in the wireless communication device 120 detects this file 150, it can verify the signature and make sure that the device id specified in the file 150 matches the one from the device. If the two checks pass, the wireless communication device 120 can provision the data synchronization language profile on the phone. Because the wireless communication device code does the check to make sure that the device id 210 in the signed packet 150 matches the one on the wireless communication device 120, the signed packet 150 cannot be reused to enable local device management sessions on a device other than the one the packet 150 was generated for.

The newly created data synchronization profile allows the wireless communication device 120 to communicate with a device management server 130. Access control lists, which allow the modification of device management nodes on the wireless communication device 120, are preconfigured on the device. For example, the access control lists can define access rights for particular nodes in a device management tree. These rights can be defined for a device management server to perform actions on the device management tree. Depending on the profile of the local device management session, such as a third-party developer, carrier testing, a cellular phone store operator, the principal that is used in the device management session can be different and can be a set of hard coded values.

This approach can be used to enable local provisioning on devices where it is not allowed in normal use. For example, this approach can be used for testing an application by third-party software developers. In this case if a developer wants to test out code on the device, the developer can provision the code locally. The secure checks for device id, registration, and/or encryption can reduce inappropriate use of local provisioning. As another example, this approach can be used by a technician in a store that services cellular phones. A flex bit in the phone can be enabled to allow the technician to diagnose the cellular phone. Thus, a flex bit on the device management tree can indicate whether local provisioning is allowed or not. The technician can also be allowed to repair the phone software and/or fix bugs locally.

The use of a device identifier and encryption can be useful because allowing a wireless communication device to connect to a device management server for local device management is a powerful feature and should be given only to a few trusted entities.

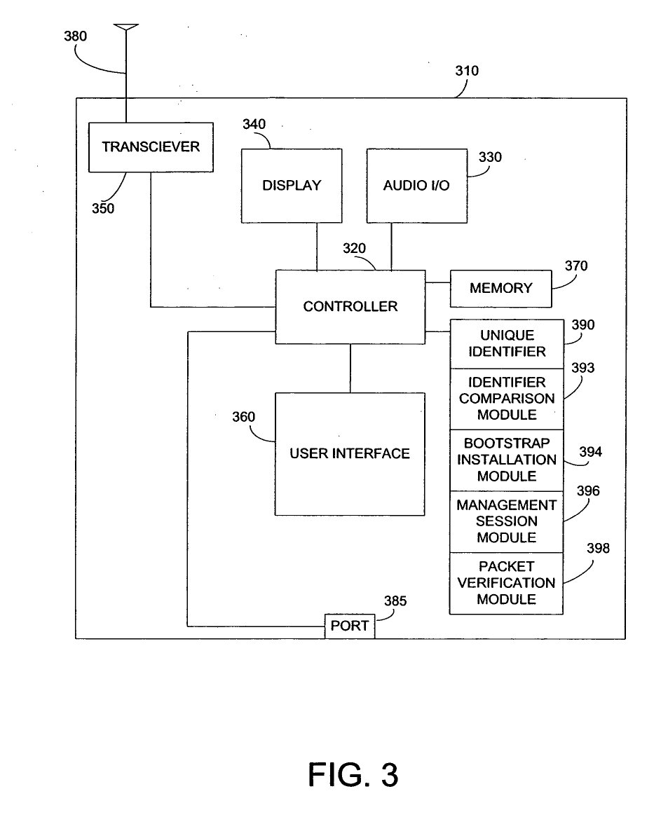

FIG. 3 is an exemplary block diagram of a wireless communication device 300, such as the wireless communication device 120, according to one embodiment. The wireless communication device 300 can include a housing 310, a controller 320 coupled to the housing 310, audio input and output circuitry 330 coupled to the housing 310, a display 340 coupled to the housing 310, a transceiver 350 coupled to the housing 310, a user interface 360 coupled to the housing 310, a memory 370 coupled to the housing 310, a port 385 coupled to the housing 310, and an antenna 380 coupled to the housing 310 and the transceiver 350. The wireless communication device 300 can also include a unique identifier 390, a device identifier comparison module 393, a bootstrap installation module 394, a management session module 396, and a packet verification module 398. The identifier comparison module 393, the bootstrap installation module 394, the device management session module 396, and the packet verification module 398 can be coupled to the controller 320, can reside within the controller 320, can reside within the memory 370, can be autonomous modules, can be software, can be hardware, or can be in any other format useful for a module on a wireless communication device 300. The unique identifier 390 may be stored in the memory 370, in a separate field, in a register, in a secure identity module, or anywhere else on the wireless communication device 300.

The display 340 can be a liquid crystal display (LCD), a light emitting diode (LED) display, a plasma display, or any other means for displaying information. The port 385 may be a port for wired connection, an infrared port, a short range wireless connection port such as a Bluetooth or 802.11 transceiver, or any other port useful for a local connection. The transceiver 350 may include a transmitter and/or a receiver. The audio input and output circuitry 330 can include a microphone, a speaker, a transducer, or any other audio input and output circuitry. The user interface 360 can include a keypad, buttons, a touch pad, a joystick, an additional display, or any other device useful for providing an interface between a user and an electronic device. The memory 370 may include a random access memory, a read only memory, an optical memory, a subscriber identity module memory, or any other memory that can be coupled to a wireless communication device.

In operation, the port 385 can be used to connect to a local device management server via a local connection and used to receive the local provisioning packet 150. The device identifier comparison module 393 can compare the device identifier 210 to the unique identifier 390. The bootstrap installation module 394 can install the bootstrap packet 150 in the wireless communication device 300 if the device identifier 210 matches the unique identifier 390. The device management session module 396 can open a local device management session with the local device management server if the bootstrap packet 150 is installed. The local connection can be a universal serial bus connection, an infrared connection, a short range wireless connection, or any other means for connecting two devices in close proximity. For example, the wireless communication device 120 may be in the same room, in the same building, or within 100 feet of the device management server 130 for a local connection.

The local provisioning packet verification module 398 can verify the local provisioning packet 150 signing certificate from a signing server 140. The bootstrap installation module 394 may then install the bootstrap packet 220 in the wireless communication device 300 if the device identifier 210 matches the unique identifier 390 and the local provisioning packet 150 is verified. The device management session module 396 may also check a local provisioning flex bit in a device management tree and can open a local device management session with the local device management server 130 if the bootstrap packet 220 is installed and if the local provisioning flex bit indicates a local device management session is allowed.

The device management session module 396 can deny a device management session if the device identifier 210 does not match the unique identifier 390 of the wireless communication device 300, if the local provisioning packet 150 is not verified, and/or if the local provisioning flex bit indicates a local device management session is not allowed.

The device management session module 396 can change a device management tree during the device management session. For example, the device management session module 396 can change a device management tree by changing configuration values stored in the device management tree in order to enable a feature, disable a feature, modify an existing feature, and/or for any other purpose.

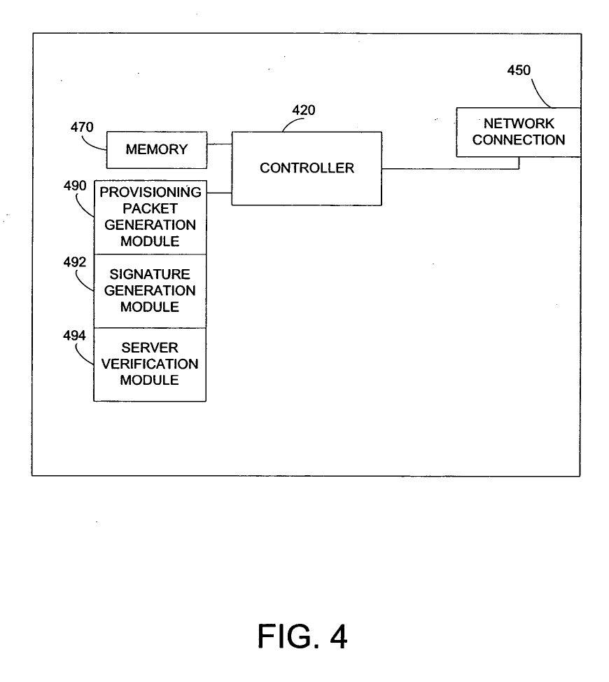

FIG. 4 is an exemplary block diagram of a remote signing server 400, such as the signing server 140. The remote signing server 400 can include a controller 420, a network connection 450, a memory 470, a local provisioning packet generation module 490, an signature generation module 492 and a requesting server verification module 494. The local provisioning packet generation module 490, the signature generation module 492, and the requesting server verification module 494 can be coupled to the controller 420, can reside within the controller 420, can reside within the memory 470, can be autonomous modules, can be software, can be hardware, or can be in any other format useful for a module on a remote signing server 400. The memory 470 may include a random access memory, a read only memory, an optical memory, a subscriber identity module memory, or any other memory. The controller 420 can control the operation of the remote signing server 400.

In operation, the network connection 450 can receive a registration from a requesting server, such as the device management server 130, for a local direct device management session with a specific wireless communication device, such as the wireless communication device 120. The local provisioning packet generation module 490 can generate a local provisioning packet, such as the local provisioning packet 150. The local provisioning packet can include a device identifier that is unique to the specific wireless communication device, the local provisioning packet can also include a bootstrap packet. The network connection 450 can send, to the requesting server, the local provisioning packet intended for the specific wireless communication device. The signature generation module 492 can sign the local provisioning packet using a private key. The requesting server verification module 494 can verify the authority of the requesting server to enter the local direct device management session.

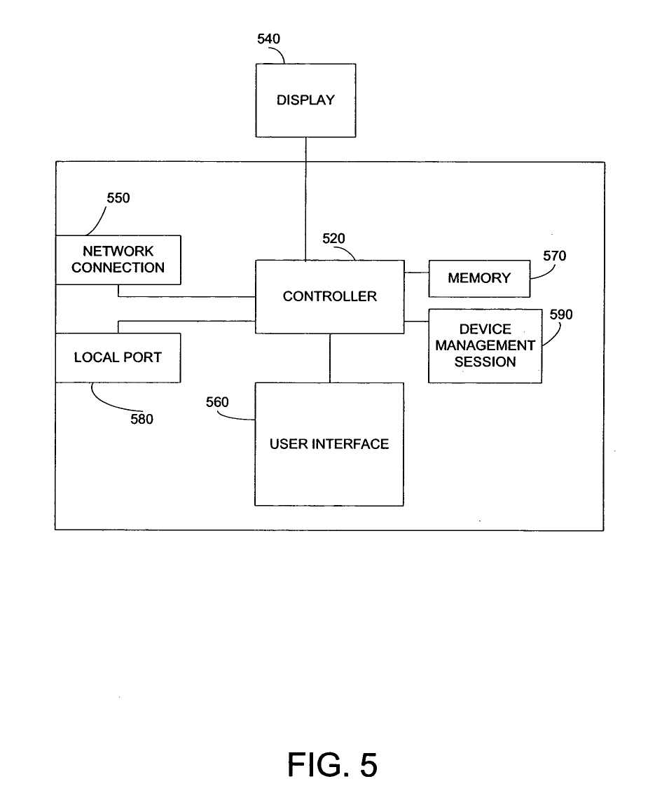

FIG. 5 is an exemplary block diagram of a local device management server 500, such as the device management server 130. The local device management server 500 can include a controller 520, a network connection 550, a user interface 560, a memory 570, a local connection port 580, and a device management session module 590. The local device management server 500 may also be connected to a display 540.

The device management session module 590 can be coupled to the controller 520, can reside within the controller 520, can reside within the memory 570, can be an autonomous module, can be software, can be hardware, or can be in any other format useful for a module on a local device management server. The memory 570 may include a random access memory, a read only memory, an optical memory, a subscriber identity module memory, or any other memory that can be coupled to a local device management server. The user interface 560 may be any user interface discussed above. The local connection port 580 can be a universal serial bus port, an infrared connection port, a short range wireless connection module, or any other port useful for a local connection between two devices. The controller 520 can control the operation of the local device management server 500.

In operation, the local connection port 580 can establish a local connection with a specific wireless communication device, such as the wireless communication device 120. The network connection 550 can send a registration to a remote signing server, such as the signing server 140. The registration can be for a direct device management session with the locally connected specific wireless communication device. The network connection 550 can receive a local provisioning packet from the remote signing server, the local provisioning packet including a device identifier that is unique to the specific wireless communication device, the local provisioning packet also including a bootstrap packet. The local connection port 580 can transfer the local provisioning packet to the specific wireless communication device. The device management session module 590 can engage in a device management session with the specific wireless communication device. The device management session module 590 can change a device management tree on the specific wireless communication device during the device management session. For example, the device management session module 590 can change the device management tree by changing configuration values stored in the device management tree on the specific wireless communication device to enable a feature, disable a feature, modify an existing feature, or to perform any other action useful in a device management tree.

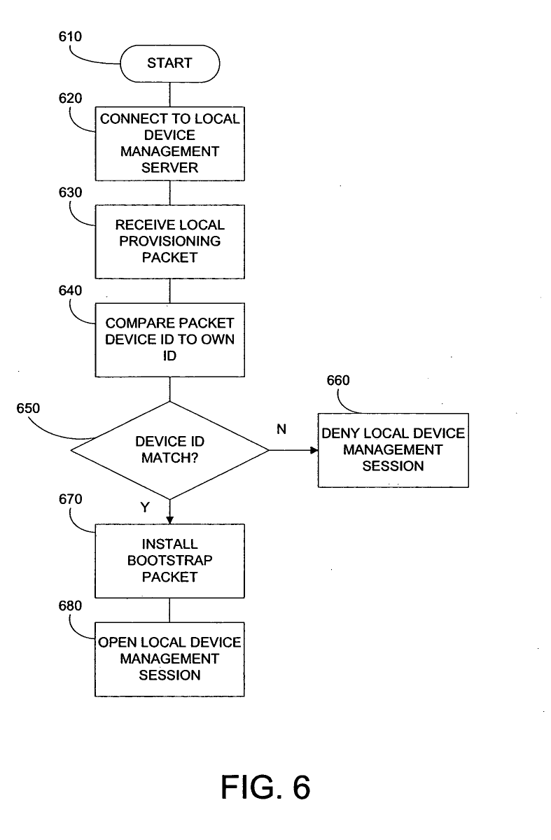

FIG. 6 is an exemplary flowchart 600 illustrating the operation of the wireless communication device 300 according to another embodiment. In step 610, the flowchart begins. In step 620, the wireless communication device 300 can connect to a local device management server via a local connection. The local connection can be a universal serial bus connection, an infrared connection, a short range wireless connection, or any other local connection. In step 630, the wireless communication device 300 can receive a local provisioning packet, the local provisioning packet including a device identifier and a bootstrap packet. In step 640, the wireless communication device 300 can compare the device identifier to a unique identifier in the wireless communication device 300. In step 650, the wireless communication device 300 can determine if the device identifier matches the unique identifier. In step 650, the wireless communication device 300 may also verify the local provisioning packet using a remote signing server's certificate. If the answer to any of the decisions in step 650 is no, in step 660, the wireless communication device 300 can deny a local device management session. If the answer to the decision in step 650 is yes, in step 670, the wireless communication device 300 can install the bootstrap packet in the wireless communication device. In step 680, the wireless communication device 300 can open a local device management session with the local device management server if the bootstrap packet is installed. The wireless communication device 300 can change a device management tree during the device management session. The wireless communication device 300 can change a device management tree by changing configuration values stored in the device management tree to enable a feature, disable a feature, and/or modify an existing feature.

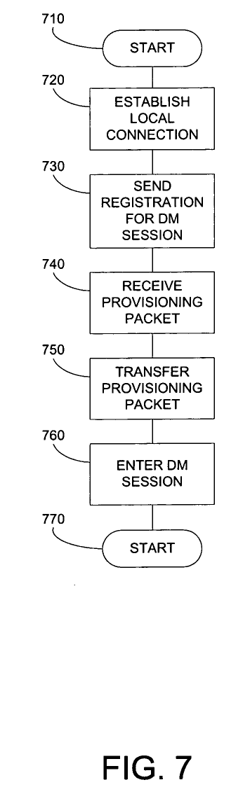

FIG. 7 is an exemplary flowchart 700 illustrating the operation of the local device management server 500 according to another embodiment. In step 710, the flowchart begins. In step 720, the local device management server 500 can establish a local connection with a specific wireless communication device. The specific wireless communication device can be locally connected via a universal serial bus connection, an infrared connection, a short range wireless connection, and/or any other local connection. In step 730, the local device management server 500 can send a registration to a remote signing server for to enable direct device management sessions with the locally connected specific wireless communication device. In step 540, the local device management server 500 can receive a local provisioning packet from the remote signing server, the local provisioning packet including a device identifier that is unique to the specific wireless communication device, the local provisioning packet also including a bootstrap packet. The bootstrap packet can include a server address and other information necessary for a client to contact the server. In step 750, the local device management server 500 can transfer the local provisioning packet to the specific wireless communication device. In step 760, the local device management server 500 can engage a device management session with the specific wireless communication device. The above procedure may only be necessary on a device that does not have a local device management profile setup. Once the procedure is performed, the specific wireless communication device may perform subsequent sessions with the local device management server 500 without extra registration. The local device management server 500 can change a device management tree on the specific wireless communication device during the device management session. For example, changing a device management tree can include changing configuration values stored in the device management tree on the specific wireless communication device to enable a feature, disable a feature, and/or modify an existing feature. In step 770, the flowchart can end.

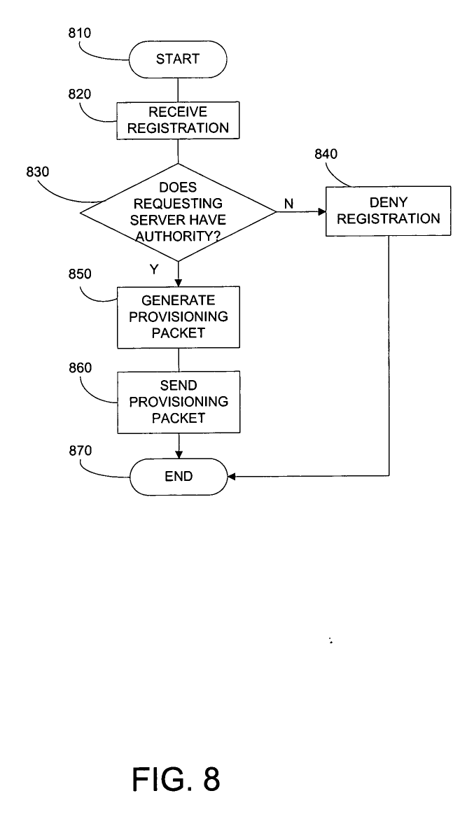

FIG. 8 is an exemplary flowchart 800 illustrating the operation of the remote signing server 400 according to another embodiment. In step 810, the flowchart begins. In step 820, the remote signing server 400 can receive a registration from a requesting server, such as the device management server 130, for a local direct device management session with a specific wireless communication device. In step 830, the remote signing server 400 can determine if the requesting server has authority to enter a local device management session. If not, in step 840, the remote signing server 400 can deny the registration and not send a local provisioning packet. If the requesting server has authority, in step 850, the remote signing server 400 can generate a local provisioning packet. The local provisioning packet can include a device identifier that is unique to the specific wireless communication device. The local provisioning packet can also include a bootstrap packet. The bootstrap packet can include a server address and other information necessary for a client, such as the specific wireless communication device to contact a server, such as the requesting server. The remote signing server 400 can also sign the local provisioning packet using a private key. In step 860, the remote signing server 400 can send, to the requesting server, the local provisioning packet intended for the specific wireless communication device.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method in a wireless communication device comprising:
connecting to a local device management server via a local connection;
receiving a local provisioning packet, the local provisioning packet including a device identifier and a bootstrap packet;
comparing the device identifier to a unique identifier in the wireless communication device;
installing the bootstrap packet in the wireless communication device if the device identifier matches the unique identifier in the wireless communication device; and
opening a local device management session with the local device management server if the bootstrap packet is installed.

2. The method according to claim 1, wherein a local connection comprises a connection selected from the group of a universal serial bus connection, an infrared connection, and a short range wireless connection.

3. The method according to claim 1, further comprising verifying the local provisioning packet using a remote signing server's certificate.

4. The method according to claim 3, wherein installing the bootstrap packet further comprises installing the bootstrap packet in the wireless communication device if the device identifier matches the unique identifier in the wireless communication device and the local provisioning packet is verified.

5. The method according to claim 1, wherein the bootstrap packet includes a server address and other information necessary for a client to contact the local device management server.

6. The method according to claim 1, further comprising denying a device management session if the device identifier does not match the unique identifier of the wireless communication device.

7. The method according to claim 1, further comprising changing a device management tree during the device management session.

8. The method according to claim 7, wherein changing a device management tree comprises changing configuration values stored in the device management tree to at least one selected from the group of enable a feature, disable a feature, and modify an existing feature.

9. The method according to claim 1, further comprising denying a device management session if the local provisioning packet cannot be verified using a remote signing server's certificate

10. A method in a local device management server comprising:
establishing a local connection with a specific wireless communication device;
sending a registration to a remote signing server for a direct device management session with the locally connected specific wireless communication device;
receiving a local provisioning packet from the remote signing server, the local provisioning packet including a device identifier that is unique to the specific wireless communication device, the local provisioning packet also including a bootstrap packet;
transferring the local provisioning packet to the specific wireless communication device; and
engaging a device management session with the specific wireless communication device.

11. The method according to claim 10, wherein the specific wireless communication device is locally connected via a connection selected from the group of a universal serial bus connection, an infrared connection, and a short range wireless connection.

12. The method according to claim 10, wherein the bootstrap packet includes a server address and other information necessary for a client to contact the server.

13. The method according to claim 10, further comprising changing a device management tree on the specific wireless communication device during the device management session.

14. The method according to claim 13, wherein changing a device management tree comprises changing configuration values stored in the device management tree on the specific wireless communication device to at least one selected from the group of enable a feature, disable a feature, and modify an existing feature.

15. A method in a remote signing server comprising:
receiving a registration from a requesting server for a local direct device management session with a specific wireless communication device;
generating a local provisioning packet, the local provisioning packet including a device identifier that is unique to the specific wireless communication device, the local provisioning packet also including a bootstrap packet; and
sending, to the requesting server, the local provisioning packet intended for the specific wireless communication device.

16. The method according to claim 15, further comprising signing the local provisioning packet using a private key.

17. The method according to claim 15, wherein the bootstrap packet includes a server address and other information necessary for a client to contact the server.

18. The method according to claim 15, further comprising verifying the authority of the requesting server to enter the local direct device management session.

19. A wireless communication device comprising:
a transceiver;
a local connection port configured to connect to a local device management server via a local connection and receive a local provisioning packet, the local provisioning packet including a device identifier and a bootstrap packet;
a unique identifier;
a device identifier comparison module configured to compare the device identifier to the unique identifier;
a bootstrap installation module configured to install the bootstrap packet in the wireless communication device if the device identifier matches the unique identifier in the wireless communication device; and
a device management session module configured to open a local device management session with the local device management server if the bootstrap packet is installed.

20. The wireless communication device according to claim 19, wherein a local connection comprises a connection selected from the group of a universal serial bus connection, an infrared connection, and a short range wireless connection.

21. The wireless communication device according to claim 19, further comprising a local provisioning packet verification module configured to verify the local provisioning packet using a remote signing server's certificate.

22. The wireless communication device according to claim 21, wherein the bootstrap installation module is further configured to install the bootstrap packet in the wireless communication device if the device identifier matches the unique identifier and the local provisioning packet is verified.

23. The wireless communication device according to claim 19, wherein the bootstrap packet includes a server address and other information necessary for a client to contact the local device management server.

24. The wireless communication device according to claim 19, wherein the device management session module is further configured to deny a device management session if the device identifier does not match the unique identifier of the wireless communication device.

25. The wireless communication device according to claim 19, wherein the device management session module is further configured to change a device management tree during the device management session.

26. The wireless communication device according to claim 25, wherein changing a device management tree comprises changing configuration values stored in the device management tree to at least one selected from the group of enable a feature, disable a feature, and modify an existing feature.

27. The wireless communication device according to claim 19, further comprising a local provisioning packet verification module configured to verify the local provisioning packet using a remote signing server's certificate,
wherein the device management session module is further configured to deny a local device management session with the local device management server if the local provisioning packet cannot be verified.

28. A local device management server comprising:
a local connection port configured to establish a local connection with a specific wireless communication device;
a network connection configured to send a registration to a remote signing server for a direct device management session with the locally connected specific wireless communication device, the network connection further configured to receive a local provisioning packet from the remote signing server, the local provisioning packet including a device identifier that is unique to the specific wireless communication device, the local provisioning packet also including a bootstrap packet;
the local connection port further configured to transfer the local provisioning packet to the specific wireless communication device; and
a device management session module configured to engage a device management session with the specific wireless communication device.

29. The local device management server according to claim 28, wherein the local connection port comprises a port selected from the group of a universal serial bus port, an infrared connection port, and a short range wireless connection module.

30. The local device management server according to claim 28, wherein the bootstrap packet includes a server address and other information necessary for a client to contact the local device management server.

31. The local device management server according to claim 28, wherein the device management session module is further configured to change a device management tree on the specific wireless communication device during the device management session.

32. The local device management server according to claim 31, wherein changing a device management tree comprises changing configuration values stored in the device management tree on the specific wireless communication device to at least one selected from the group of enable a feature, disable a feature, and modify an existing feature.

33. A remote signing server comprising:
a network connection configured to receive a registration from a requesting server for a local direct device management session with a specific wireless communication device; and
a local provisioning packet generation module configured to generate a local provisioning packet, the local provisioning packet including a device identifier that is unique to the specific wireless communication device, the local provisioning packet also including a bootstrap packet,
wherein the network connection is further configured to send, to the requesting server, the local provisioning packet intended for the specific wireless communication device.

34. The remote signing server according to claim 33, further comprising an signature generation module configured to sign the local provisioning packet using a private key.

35. The remote signing server according to claim 33, wherein the bootstrap packet includes a server address and other information necessary for a client to contact the server.

36. The remote signing server according to claim 33, further comprising a requesting server verification module configured to verify the authority of the requesting server to enter the local direct device management session.
